(19) United States
(12) Patent Application Publication
(10) Pub. No.: US 2005/0218578 A1
(43) Pub. Date: Oct. 6, 2005

(54) Fixing pincers for ceiling boards

(76) Inventor: Francesco Parrinello, Frankfurt (DE)

Correspondence Address: MARGER JOHNSON & MCCOLLOM, P.C., 210 SW MORRISON STREET, SUITE 400, PORTLAND, OR, 97204, US

(21) Appl. No.: 10/513,430

(22) PCT Filed: Apr. 30, 2003
(86) PCT No.: PCT/EP03/04573

§ 371 Date: May 11, 2005

(30) Foreign Application Priority Data
May 3, 2002 (DE) 202 07 010.7

(51) Int. Cl. B25B 5/04

(52) U.S. Cl. 269/238

(57) ABSTRACT

Fixing clamp for ceiling panels with a support part to provide support on a ceiling section structure, a pressing part articulatingly joined to the support part and a clamping plate articulatingly joined to the pressing part, the fixing clamp being displaceable between an open position and a closed position, in which closed position the ceiling panel is fixed to the ceiling section structure.

The invention relates to a device for fitting ceiling panels on a ceiling section structure.

Panels, such as plaster panels, plasterboard panels, timber panels, so-called one-man panels or similar, are manually mounted on the ceiling of a building by fitters as a rule and the job is associated with a considerable amount of labour as well as increased risk of injury for the fitters. At least two fitters are needed in order to hold a panel in the requisite mounting position on the ceiling, so that a third fitter can secure the panel with screws or similar.

This method of working is very time-consuming and labour-intensive.

A known approach is to fix the ceiling panel to the ceiling section construction by means of telescopic supports, after which they can be permanently fixed on the ceiling by screws. However, the telescopic supports are awkward to handle and do not allow any fine corrections to be made to the mounting position once the ceiling panel has been clamped with the telescopic supports against the ceiling section structure.

Patent specification DE 19843839 A1 discloses a device for fitting panels on suspended ceiling constructions, which has an essentially U-shaped section and is placed with one leg of the “U” on the top face of a ceiling section bar, so that the ceiling panel to be mounted is placed on the other leg of the “U”. The ceiling panel is held in its position as a result. However, depending on the thickness of the ceiling section bar and the ceiling panel, and because the distance between the two legs of the U-section is fixed, the known fitting system does not allow the ceiling panel to be securely fixed and a certain distance is left between them.

Accordingly, the objective of the invention is to propose an aid to facilitate the fitting of ceiling panels on a ceiling section structure.

This objective is achieved by means of a fixing clamp for ceiling panels with a support part which is placed on a ceiling section structure, a pressing part articulatingly linked to the support part and a clamping plate articulatingly linked to the pressing part, which fixing clamp is displaceable between an open position and a closed position, in which closed position the ceiling panel is secured to the ceiling section structure.

The fixing clamp proposed by the invention enables the ceiling panel intended for mounting on the ceiling section structure to be easily and reliably fixed. To achieve this, the spring force is preferably set so that the ceiling panel is reliably fixed on the ceiling section structure on the one hand and fine corrections can be made to the mounting position on the other hand.

The invention will be explained in more detail below with reference to examples of preferred embodiments illustrated in the appended drawings, in which:

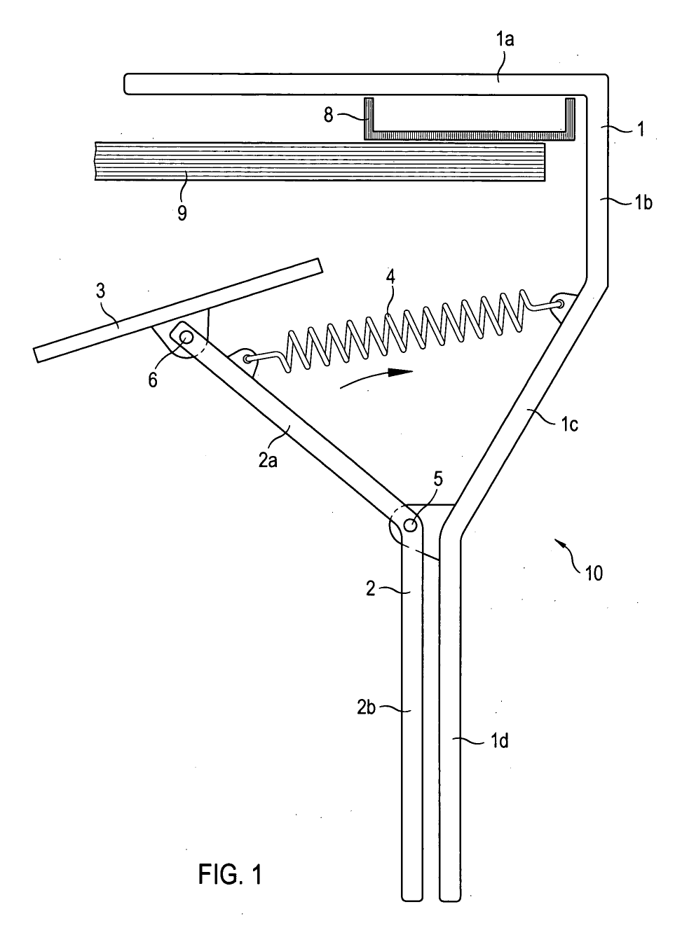

FIG. 1 is a side view of one example of an embodiment of the fixing clamp for ceiling panels proposed by the invention, illustrated in the open position;

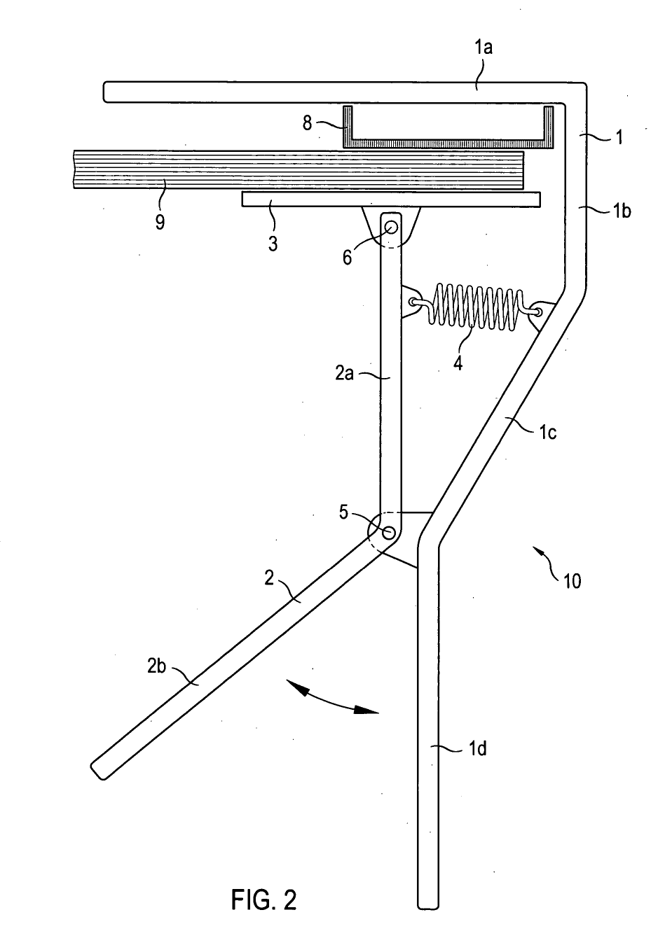

FIG. 2 is a side view of the fixing clamp illustrated in FIG. 1 in the closed position; and

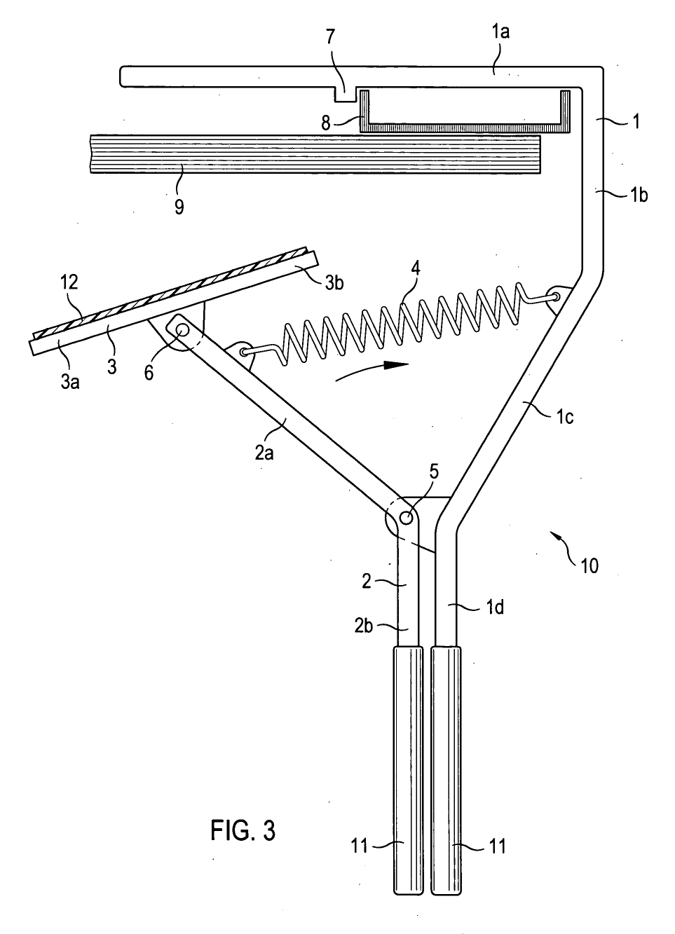

FIG. 3 is a side view of an example of a different embodiment of the fixing clamp proposed by the invention, illustrated in the open position.

The fixing clamp 10 has a support part 1, which can be placed on a ceiling section structure 8. At least the top leg 1a of the support part 1 is therefore preferably of a flat design. Adjoining the top leg 1a, preferably at a right-angle, is a vertical piece 1b and adjoining this an angled piece 1c, 1d. The support part 1 is joined to a pressing part 2, also provided in the form of an angled piece, by means of an articulated joint 5. Mounted between the support part 1 and press part 2 is a spring 4, the tension force of which moves the fixing clamp 10 into the closed position illustrated in FIG. 2. In order to open the clamp to the open position illustrated in FIG. 1, the user must apply force against the tension force of the spring. However, the spring force is preferably selected so that although the ceiling panel 9 is reliably fixed on the ceiling section structure 8, small corrections can still be made to the position by the fitter.

Connected to the pressing part 2 by means of another articulated joint 6 is the clamping plate 3, which is pressed by the spring force against the ceiling panel 9 from underneath.

The fixing clamp 10 is operated as follows. The fitter holds the ceiling panel 9 to be mounted against the ceiling section structure 8 with one hand, takes the fixing clamp 10 with the other hand and moves it manually against the force of the spring 4 into the open position illustrated in FIG. 1, engages round the ceiling section structure 8 with the support part 1 and then fixes the ceiling panel 9 against the ceiling section structure 8 by letting go of the handle ends 1d, 2b. The panel can then be permanently secured to the ceiling section structure by means of screws, without any further effort to retain it.

An example of another embodiment of the fixing clamp is illustrated in FIG. 3. The function is essentially the same as that of the first embodiment. However, a covering 12 made from rubber or plastic material is additionally provided on the clamping plate 3 to prevent the surface of the ceiling panel 9 from being damaged. One side 3b of the clamping plate is also of a longer design than the other side 3a of the clamping plate relative to the articulated joint 6 to prevent the clamping plate 3 from tilting downwards in the open position. In the embodiment illustrated in FIG. 3, a projection 7 is also provided on the support part 1 and handle parts 11 are provided at the handle ends 1d, 2b of the support part and pressing part to improve handling of the fixing clamp.

The fixing clamp proposed by the invention therefore enables ceiling panels to be fixed simply and reliably so that they can then be permanently secured to a ceiling section structure.

### List of reference numbers

1 Support part
2 Pressing part
3 Clamping plate
4 Spring
5 Articulated joint
6 Articulated joint
7 Projection
8 Ceiling section structure
9 Ceiling panel
10 Fixing clamp
11 Handle
12 Covering

1. Fixing clamp for ceiling panels comprising:
a support part (1) to provide support on a ceiling section structure (8),
a pressing part (2) articulatingly joined to the support part (1) and
a clamping plate (3) articulatingly joined to the pressing part (2),
the fixing clamp (10) being displaceable between an open position and a closed position, in which closed position the ceiling panel (9) is fixed on the ceiling section structure (8).

2. Fixing clamp as claimed in claim 1 with a spring (4) is disposed between the support part (1) and pressing part (2) above an articulated joint (5) between the two parts but permits manual fine corrections to be made to the position of the ceiling panel (9).

3. Fixing clamp as claimed in claim 2, in which the spring (4) exerts a force between the support part (1) and pressing part (2), which holds the fixing clamp (10) in the closed position.

4. Fixing clamp as claimed in one of claims 1 to 3, in which the support part (1) has a projection (7) to provide purchase on a ceiling section structure (8).

5. Fixing clamp as claimed in one of claims 1 to 4, in which the support part (1) and/or pressing part (3) has handles (11) made from plastic.

6. Fixing clamp as claimed in one of claims 1 to 5, which is made from sheet steel or plastic.

7. Fixing clamp as claimed in one of claims 1 to 6, in which the clamping plate (3) is of an asymmetrical design by reference to an articulated joint (6) with the pressing part (2) to prevent the clamping plate (3) from tilting downwards.
